(19) United States
(12) Patent Application Publication
(10) Pub. No.: US 2025/0091168 A1
(43) Pub. Date: Mar. 20, 2025

(54) RECEIVING MAGAZINE FOR WORKPIECES

(71) Applicants: Thomas LORENSCHEIT, Neu Darchau (DE); Nadine LORENSCHEIT, Neu Darchau (DE)

(72) Inventors: Thomas LORENSCHEIT, Neu Darchau (DE); Nadine LORENSCHEIT, Neu Darchau (DE)

(21) Appl. No.: 18/827,397

(22) Filed: Sep. 6, 2024

(30) Foreign Application Priority Data
Sep. 18, 2023 (EP) 23197920.4

(51) Int. Cl. B23Q 7/10; B23Q 7/04

(52) U.S. Cl. CPC B23Q 7/10; B23Q 7/046

(57) ABSTRACT

A magazine for holding a plurality of workpieces in a workpiece machining process having a flat tray which includes a first pair of mounting rails running along a first direction and a second pair of mounting rails running along a second direction perpendicular to the first direction. The magazine has a plurality of first bounding elements positionally displaceable and fastened to the mounting rails of the first pair with their longitudinal direction running in the second direction and a plurality of second bounding elements positionally and fastened to the mounting rails of the second pair in their longitudinal direction running in first direction. The mounting rails of the first and second pairs and the first and second bounding elements coordinate with one another such that regardless of arrangement and positioning first and second bounding elements are arranged on and fastened to one of first or second pairs of mounting rails.

### TECHNICAL FIELD

The invention relates to a magazine for holding a plurality of, in particular identical, workpieces in a workpiece machining process having the features of the having a flat tray and having sectioning elements that can be arranged in different positions in the area of the tray for geometrically determining and bounding a plurality of setdown positions for the workpieces on the flat tray. It further relates to a machining station for machining workpieces, in particular by cutting, which contains such a magazine.

### BACKGROUND ART

In manufacturing, it is known to subject workpieces to machining processes in workpiece machining machines in order to finally obtain a finished part from blanks or partially finished products, where applicable by means of machining processes carried out successively on different workpiece machining machines. Different workpiece machining machines are used here, especially also metal-cutting machines, for example multi-axis lathes, milling machines, grinding machines and the like. In these workpiece machining machines, typically one workpiece is machined per machining run, wherein this workpiece must be introduced into the workpiece machining machine in a predetermined position, typically clamped there in a corresponding clamping device and, after the machining process, removed again from a machining space of the workpiece machining machine in which it was previously positioned or clamped.

In most cases, single and individual workpieces are not machined separately in production and with an individual process, but series machining is carried out, sometimes in a small series but sometimes also in a large series in which similar workpieces are machined in the workpiece machining machine one after the other using a machining process with an identical sequence, for example in a similar manner contour-forming machining. For this purpose, it is necessary to repeatedly introduce a workpiece into the machining space of the workpiece machining machine at a specific clock rate, to position or clamp it there, to remove the workpiece from the machining space of the workpiece machining machine once machining has been completed and then to insert a workpiece that is to be machined next, and so on. In order to optimize the entire machining sequence with regard to maximizing throughput, various measures have been devised and are applied in modern machining processes.

A larger number of workpieces to be processed are thus made available in the area of the machining machine, which can then be rapidly introduced into the machining space of the workpiece machining machine in a loading process in such a manner that no dead times or waiting times ensue. The workpieces are typically made available in magazines which are arranged like a table on an apparatus in the area of the workpiece machining machine and on which workpieces which are yet to be machined and are therefore in a waiting position are positioned in an ordered manner. Depending on the shape of the workpieces and the type of transfer into the machining space of the workpiece machining machine, workpieces can for example be arranged in stacked form on top of one another. In many cases, the workpieces are also arranged in a kind of matrix, in columns and rows, above or next to one another.

Such magazines can also be provided for workpieces removed from the machining space, so that the workpieces that are either finished after the machining process or that are subsequently to be subjected to further machining are located there in an ordered holding facility and, in particular, in the event that they are to be further machined, can be fed to another workpiece machining machine.

Furthermore, robots are increasingly being used for automation and the associated shortening of the machining sequence, be they conventional industrial robots or collaborative robots, so-called cobots, which take over the actual loading and/or unloading process, i.e. they grasp workpieces held in a ready supply in a magazine one at a time and transfer them to the machining space of the machining machine and position them there or hand them over to a clamping device and, where applicable, after machining has been completed, grasp the processed workpiece in the machining space, take it out of the machining space and place it in an ordered manner in a provided holding facility, for example in another magazine. A machine operator then only has to supervise the process and intervene if any malfunctions occur, and must ensure that in the magazine there is always a supply of workpieces in the waiting position that still need to be machined, which the robot can then pick up and handle automatically and feed to the workpiece machining machine, or ensure that removed workpieces are taken away after machining and sent to their further destination, be this further machining on another workpiece machining machine or to further logistical elements after completion of workpiece machining, or is however to be sent to shipping for a further use, which may also be further machining.

In particular, when a workpiece machining machine is not used to continuously process the same workpieces of the same dimensions and geometry as part of continuous series production, but rather to carry out successive small-series processing in which the workpieces to be machined vary in their geometries and/or dimensions, there is now a need to be able to set up the magazines variably and to adapt them to the respective geometries and dimensions of the workpieces in such a way that the workpieces can be arranged and held there in a defined and positionally accurate manner.

A proposal to design such a variable magazine is disclosed and described in EP 2 314 414 A1. The magazine described therein comprises a flat tray base which has holes in a matrix-like and grid-like arrangement into which pins can be inserted. These pins then form locating points for workpieces, so that by equipping the tray base with pins with different spacings, smaller or larger partitions or nests can be obtained on or in which a workpiece can be arranged with a predetermined abutment, namely an abutment against the outer circumferences of the respective neighboring pins. If then, in the course of a change in the machining to be carried out in the workpiece machining machine, the machine and the process have to be converted to different and differently shaped or dimensioned workpieces, this is done in relation to the setting of the magazine by an operator who redistributes the pins in the holes in such a way that the tray partitions or nests thus formed are matched to the workpieces to be machined in the newly set-up process.

Although the known solution already provides the desired flexibility in setting-up and converting the magazine, disadvantages and problems nevertheless remain. Inserting or re-inserting the pins requires a comparatively high amount of effort. An operator must insert and fasten each individual pin in a hole provided for setting-up the magazine corresponding to the type of workpiece to be accommodated, or in the case of conversion must also remove the pins previously arranged in other holes and, if necessary, move them to a new hole. This requires a comparatively high amount of time when converting the magazine. In addition, conversion errors can occur if an operator accidentally inserts one of the pins into a wrong hole and not into the hole intended for the specific setup.

A further problem is that, at least when the handling of the workpieces as they are brought into the machining space of the workpiece machine and when they are being set up there (positioning or transferring to the clamping device) and/or when the workpieces are being removed from the machining space is carried out with the aid of a robot, knowledge of a center point or a position of a center axis of the workpiece is of vital importance for the positioning of the robot arm gripper when it is approaching the magazine to grasp the workpiece. Accordingly, the robot must be taught the position of this center point in relation to the geometry of the magazine. However, since in the known magazine with the pins the workpieces are only in contact, in a punctiform or linear abutment, with sections of their side contours the pins bounding the respective partition or the respective nest, an exact position of the center cannot simply be determined on the basis of the edge geometry but complex calculations are required on account of the V-shaped contact resulting here.

### SUMMARY OF THE INVENTION

The object of the present invention is to provide an improvement and a simplification of a magazine that is adjustable or adaptable with regard to the tray partitions.

The invention achieves this object with a magazine proposed here for holding a plurality of, in particular identical, workpieces (15, 16, 17, 18) in a workpiece machining process and having a flat tray (4) and having sectioning elements that can be arranged in different positions in the area of the tray (4) for geometrically determining and bounding a plurality of setdown positions (14) for the workpieces (15, 16, 17, 18) on the flat tray (4), characterized by a first pair of mounting rails that run parallel to one another, are opposite one another and are mounted on the tray along a first direction (x direction) and by a second pair of mounting rails (3) that run parallel to one another, are opposite one another and are mounted on the tray (4) along a second direction (y direction) that is perpendicular to the first direction (x direction), wherein the sectioning elements are formed by a plurality of first slat- or rod-shaped bounding elements (5) that are positionally displaceable and with their longitudinal direction in the second direction (y direction) can be fastened to the two mounting rails (2) of the first pair of mounting rails (2), and by a plurality of second slat- or rod-shaped bounding elements (7), which can be displaced in position and can be fastened with their longitudinal direction in the first direction (x direction) to the two mounting rails (3) of the second pair of mounting rails (3), wherein the mounting rails (2) of the first pair of mounting rails (2), the mounting rails (3) of the second pair of mounting rails (3), the plurality of first bounding elements (5) and the plurality of second bounding elements (7) are designed and coordinated with one another in such a manner that, regardless of the arrangement and positioning of the plurality of first bounding elements (5) and the plurality of second bounding elements (7) on the respectively associated pair of mounting rails (2, 3), the respective other plurality of second (7) or first (5) bounding elements can be arranged and fastened to the respectively associated pair of mounting rails (3, 2). Advantageous developments of such a magazine are characterized by guide sections (6) formed in the region of the longitudinal ends of the bounding elements (5, 7) and by holding and guide structures (9) provided in the mounting rails (2, 3) for receiving and guiding the guide sections (6) of the corresponding bounding elements (5, 7); characterized in that the holding and guide structures (9) in the mounting rails (2) of the first pair are provided in a first height position of a third direction (z direction) running perpendicular not only to the first direction (x direction) but also to the second direction (y direction) along the first direction (x direction), and that the holding and guide structures (9) in the mounting rails (3) of the second pair are provided in a second height position of the third direction (z direction) running along the second direction (y direction), wherein the first and the second height positions are selected such that the first bounding elements (5) and the second bounding elements (7) are arranged in different positions along the third direction (z direction) such that they rest on one another or do not touch one another and can thus be displaced independently of one another; characterized in that in the holding and guide structures (9, 12) in the mounting rails (2, 3) first latching means (12) are provided at predetermined grid positions, for interaction with second latching means (11) provided in the region of the guide sections (6) of the bounding elements (5, 7) in order to position and fasten the bounding elements (5, 7) at predetermined grid positions on the mounting rails (2, 3); characterized in that the holding and guide structures (9, 12) in the mounting rails (2, 3) and the guide sections (6) of the bounding elements (5, 7) are designed in such a manner that the bounding elements (5, 7) are each integrated into the holding and guide structures (9, 12) of the associated pair of mounting rails (2, 3) and can be removed from these holding and guide structures (9, 12) in order to be able to variably adjust the number of the respective plurality of first (5) and second (7) bounding elements; characterized in that the flat tray (4) is arranged on a base and can be tilted relative to the base at an in particular selectable adjustable angle about a pivot axis; characterized in that the pivot axis is arranged parallel to a mounting rail (2, 3) and in particular in the region thereof; characterized by plug-in pieces (19) which can be inserted into compartments (14) formed between the bounding elements (5, 7) and which have a receptacle for receiving a workpiece (18); characterized in that the first pair of mounting rails (2) and the second pair of mounting rails (3) together form a frame which, in a plan view, encloses an inner support region; characterized in that all of the mounting rails (2, 3) are of equal length; characterized in that it is arranged on a roller table which in particular has means for the positionally determined connection to a workpiece feed station of a machining station for the machining of workpieces (15, 16, 17, 18). A further aspect of the solution according to the invention also consists in a machining station for the machining, in particular by cutting, of workpieces with a workpiece machining machine (21), a workpiece feed station (24) for positioning a plurality of workpieces (15, 16, 17, 18) to be sequentially machined in the workpiece machining machine (21) and/or for positioning finished workpieces (15, 16, 17, 18) removed from the workpiece machining machine (21), and having a robot for automatically loading the workpiece machining machine (21) with workpieces (15, 16, 17, 18) provided in the workpiece feed station (24) and/or for unloading the workpiece machining machine (21) and placing the machined workpieces (15, 16, 17, 18) in the workpiece feed station (24), characterized by a magazine provided in the workpiece feed station (24) (1) according to any of the preceding claims, a possible advantageous development of that the robot is a collaborative robot.

A magazine proposed by this invention for receiving a plurality of, in particular identical, workpieces in a workpiece machining process thus first comprises a flat tray and in addition sectioning elements that can be arranged in different positions in the area of the tray and serve for geometrically determining and bounding a plurality of setdown positions for the workpieces on the tray. What is special is that the magazine has a first pair of mounting rails that run parallel to one another and are opposite one another and are mounted on the tray along a first direction, an x direction, and that it also has a second pair of mounting rails that run parallel to one another and are opposite one another and are mounted on the tray along a second direction, a y direction, that is perpendicular to the first direction, the x direction. In the magazine proposed here according to the invention, the sectioning elements are formed by a plurality of first slat- or rod-shaped bounding elements which are positionally displaceable and can be fastened with their longitudinal direction in the second direction, the y direction, on the two mounting rails of the first pair of mounting rails and further formed by a plurality of second slat- or rod-shaped bounding elements which are positionally displaceable and can be fastened with their longitudinal direction in the first direction, the x direction, on the two mounting rails of the second pair of mounting rails. Furthermore, the mounting rails of the first pair of mounting rails, the mounting rails of the second pair of mounting rails, the plurality of first bounding elements and the plurality of second bounding elements are designed and coordinated with one another in such a manner that, regardless of the arrangement and positioning of the plurality of first bounding elements and of the plurality of second bounding elements on the respective associated pair of mounting rails, the respective other plurality of second or first bounding elements can be arranged and fastened on the respective associated pair of mounting rails. In other words, regardless of the arrangement and distribution of the bounding elements running in the x direction, the bounding elements running in the y direction can be arranged and positioned as required and, conversely, regardless of the arrangement and positioning of the bounding elements running in the y direction, the bounding elements running in the x direction can be arranged and positioned as required.

This inventive and new design of a magazine for workpieces, in which the sectioning elements are not formed by pins as known from the prior art but by slat-shaped or rod-shaped bounding elements which can be fastened to laterally arranged mounting rails, ensures on the one hand that the magazine can be converted much more easily. Instead of having to move a large number of pins, a conversion can be carried out by simply moving or rearranging the significantly fewer bounding elements present. Since the bounding elements that run in the x direction and the bounding elements that run in the y direction can in each case be positioned and set up independently of each other, such installation or conversion can also be carried out quickly and easily. A further advantage is that due to the slat- or rod-shaped bounding elements the rectangular or square sections or setdown positions thus obtained are bounded peripherally by a straight edge, so that when a workpiece is arranged in the section thus formed, the position of a workpiece center point or a workpiece center axis can be easily determined by calculation, starting from the edges abutting the bounding elements. This allows a simple calculation and thus an easier setting-up of a robot, provided such a robot is to handle the workpieces held in the magazine according to the invention.

In principle, it may be possible in particular to arrange first and second bounding elements in different numbers on the mounting rails and to fasten them in different positions thereon. Accordingly, a magazine according to the invention can be provided or equipped with a greater number of first or second bounding elements, wherein in a specific configuration of the magazine not all of the bounding elements necessarily have to be mounted. In particular, when comparatively large-dimensioned tray partitions are to be set, i.e. the bounding elements are to be fastened to the mounting rails with comparatively large distances between them, only a few such bounding elements are required and superfluous bounding elements can be removed altogether. It is also possible to provide bounding elements of different shapes, with which geometrically matching receptacles can be created according to the shape and design of the workpieces to be accommodated. For example, for particularly flat workpieces, bounding elements with a small height extension can be provided, while for tall workpieces, bounding elements with a greater height extension can be provided. Accordingly, several sets of differently designed bounding elements can thus belong to the magazine equally as a set or a modular system.

Furthermore, the first and second bounding elements can be of a different nature, but there can also be bounding elements of the same shape which can be used either as first or second bounding elements. Such a variant is even advantageous in that it reduces the variety of parts of a magazine according to the invention and also simplifies the structure, since an operator no longer has to distinguish between the first or second bounding elements but can use a uniform bounding element either as the first bounding element or as the second bounding element, depending on the installation position then selected.

The magazine according to the invention can be made in particular of metal, for example of aluminum or even of steel, such as stainless steel, e.g. a chromium-nickel steel. However, it can also be made of other materials that are sufficiently dimensionally stable and rigid, for example a suitable plastic.

For guiding and fastening the bounding elements on the mounting rails, guide sections can be formed in the area of the longitudinal ends of the bounding elements and holding and guide structures can be provided in the mounting rails in which the guide sections of the corresponding bounding elements can be received and guided. Here, for example, T-shaped projections can be formed at the respective longitudinal ends of the bounding elements and corresponding T-slots can be formed in the mounting rails. However, other types of corresponding structures can also be considered, which in particular allow the bounding elements to be moved along the longitudinal direction of the associated mounting rails.

In order to achieve an independence in the displacement and attachment of the bounding elements to the mounting rails, it can be provided that the holding and guide structures in the mounting rails of the first pair are provided in a first height position of a third direction, the z direction, running perpendicular to both the first direction, the x direction, and the second direction, the y direction, along the first direction, i.e. the x direction, and that the holding and guide structures in the mounting rails of the second pair are provided in a second height position of the third direction, the z direction, running along the second direction, y direction, and that furthermore the first and the second height positions are selected such that the first bounding elements and the second bounding elements are arranged in different positions along the third direction, the z direction, in such a manner that they rest on one another or do not touch one another and can thus be displaced independently of one another. In other words, a superimposed arrangement with the first bounding elements beneath second bounding elements is obtained, which then enables an independently displaceable and adjustable positioning of the bounding elements in the corresponding superimposed levels.

In principle, it can be provided that the bounding elements on the mounting rails are infinitely adjustable and can be fastened in any position on the mounting rails. For example, an adjustment can be automatic and motor-driven, wherein this is usually not necessary since an adjustment can also be made quickly and easily manually by an operator. In order to simplify setting here, it can be provided that first latching means are provided in the holding and guide structures in the mounting rails at prespecified grid positions and that in the area of the guide sections of the bounding elements second latching means are formed which interact with the first latching means in such a way that they can lock the bounding elements in the respective grid positions assumed. Here, for example, spring-loaded pins can be provided on the guide sections of the bounding elements, which pins engage in correspondingly formed holes in the mounting rails and from which they can in turn be released, wherein the holes are formed correspondingly in the grid positions distributed according to the prespecified grid. Other types of latching means are also conceivable here.

In order to be able to flexibly equip the respective pairs of mounting rails with a prespecifiable and selectable number of first or second bounding elements, the holding and guide structures of the associated pair of mounting rails and the guide sections of the corresponding bounding elements can be designed in such a way that the bounding elements with their guide sections can be inserted into the holding and guide structures and received therein or be removed from them again. This results in the advantageous flexibility of the magazine thus formed, as already described above.

In the magazine according to the invention, it can further be provided that the flat tray is arranged on a base and can be tilted relative to the base about a pivot axis at an angle that can in particular be freely selected. This makes it possible to adjust the inclination of the magazine, which, if workpieces are wetted with a coolant, a lubricant or a similar medium as a result of previous machining, can, for example, promote the drainage and dripping-off of such a medium. A setting can also be made that allows workpieces with complex shapes to be gripped more easily with an automated system, i.e. a robot's gripper arm. The pivot axis can in particular be provided parallel to a mounting rail and advantageously in the area of these mounting rails, i.e. essentially below or slightly offset in front of or behind the mounting rails, so that the entire area bounded by the mounting rails can be adjusted in an upward inclination.

In a further possible development, the magazine according to the invention can comprise plug-in pieces which can be inserted into the receiving positions or the compartments formed by the bounding elements in the spaces left between them and which have a receptacle for receiving a workpiece. With such plug-in pieces, in particular those workpieces can be positioned in a magazine according to the invention which have base contours that are unsuitable for direct insertion into the receiving position or compartments, for example they become very narrow towards an end to be arranged at the bottom or the like.

In particular, in a magazine according to the invention, the first pair of mounting rails and the second pair of mounting rails can together form a frame which, in a plan view, runs all the way around and encloses an inner support region. The mounting rails themselves can thereby also bound external receiving areas or compartments and thus serve as bounding elements. In order to create in particular square receiving positions and compartments in a simple manner, it can be advantageous if all mounting rails are of the same length.

In particular, when workpieces received in a magazine according to the invention have to be moved from one machining station to another machining station, for example for a subsequent further machining step or for packing into shipping containers or similar, it can be advantageous for the magazine to be arranged on a roller table, wherein it is further advantageous if this roller table has means for position-determined connection to a workpiece feed station of a machining station for the machining of workpieces. Such means ensure that the magazine in the workpiece feed station is always in a defined and constantly identical position, so that, in the case of automated further transport using a robot, for example, the robot continues to know or recognize the positions in the magazine given to it once, even if the magazine together with the roller table has first been moved to the workpiece feed station and precisely positioned there using the means for position-determining connection.

A further embodiment of the invention consists of a machining station for the processing, in particular by cutting, of workpieces with a workpiece machining machine, a workpiece feed station for positioning a plurality of workpieces to be sequentially machined in the workpiece machining machine and/or for positioning finished workpieces removed from the workpiece machining machine, and having a robot for automatically loading the workpiece machining machine with workpieces provided in the workpiece feed station and/or for unloading the workpiece machining machine and placing the machined workpieces in the workpiece feed station, wherein a magazine as described above is provided in the workpiece feed station. The robot can in particular be a collaborative robot (cobot).

### BRIEF DESCRIPTION OF THE DRAWINGS

Further advantages and features of the invention will be apparent from the following description of possible embodiments and from the accompanying figures. In the figures:

FIG. 1 shows a three-dimensional view of a possible design variant of a magazine according to the invention;

FIG. 2 shows a plan view of the magazine from FIG. 1;

FIG. 3 shows a side view of the magazine from FIG. 1;

FIG. 4 shows a sectional view of the magazine from FIG. 1 along the section line marked A-A in FIG. 2;

FIG. 5 shows an enlarged view in section of a detail of the magazine from FIG. 1 corresponding to the area designated B in FIG. 4;

FIG. 6 shows a three-dimensional view of a magazine according to the invention in a first apparatus for receiving a first type of workpiece and circular-cylindrical workpieces of a first shape accommodated therein;

FIG. 7 shows a plan view of the arrangement according to FIG. 6;

FIG. 8 shows a three-dimensional view of a magazine according to the invention in a second apparatus for receiving a second type of workpiece and cuboid workpieces accommodated therein;

FIG. 9 shows a plan view of a magazine according to the invention in a third apparatus for receiving a third type of workpiece and circular-cylindrical workpieces of a second shape accommodated therein;

FIG. 10 shows a three-dimensional view of a magazine according to the invention in a fourth apparatus with inserted plug-in pieces in which workpieces of a fourth type can be fastened;

FIG. 11 shows a three-dimensional view of a workpiece machining station with a magazine according to the invention installed therein.

The figures show possible embodiments and variants of magazines according to the invention, and also sketch a workpiece machining station according to the invention provided with such a magazine according to the invention. It should be noted here that the representations do not show all features and technical details but are rather to be understood as schematic representations in which nevertheless such technical features as are necessary for a deeper understanding of the invention or have proven to be advantageous technical features are shown and illustrated. The representations are also not necessarily to scale. Furthermore, it should be noted that the exemplary embodiments shown here and explained in more detail below by no means exhaustively cover all possible embodiments of the invention but only represent a particular selection. There are numerous other possibilities for realizing the invention, which will be readily apparent to the person skilled in the art from the foregoing general description and also from studying the following description of possible design variants. In the following description of the exemplary embodiments, prospects are also given regarding further design possibilities, application possibilities and additional technical features, which do not relate only to the specifically described exemplary embodiments but can be used and employed very generally in connection with the invention.

### DETAILED DESCRIPTION

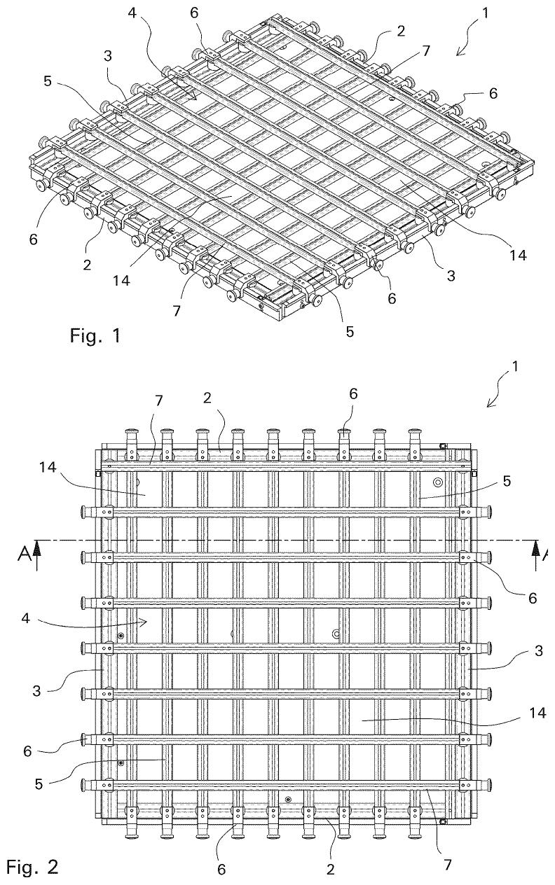

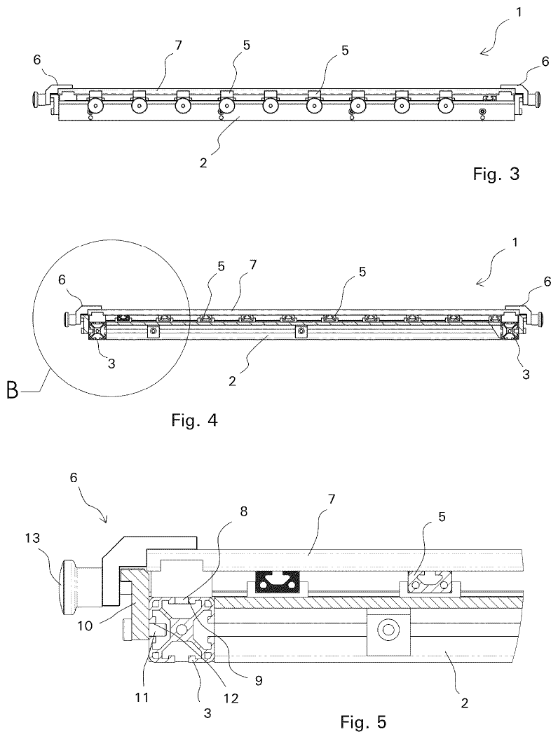

In the accompanying drawings, firstly in FIGS. 1 to 5, a possible embodiment of a magazine 1 according to the invention is shown in various views. FIG. 1 shows a three-dimensional view, FIG. 2 a plan view, FIG. 3 a side view, FIG. 4 a sectional view along the section line A-A from FIG. 2, and FIG. 5 an enlarged detailed view of the section marked B from FIG. 4.

The magazine 1 firstly comprises mounting rails running all the way around like a frame, namely a pair of first mounting rails 2 running parallel to one another and opposite one another and a pair of second mounting rails 3 running parallel to one another and opposite one another. The mounting rails 2, 3 are fixedly mounted on a base forming a flat tray 4. The first mounting rails 2 run in their longitudinal extension perpendicular to the respective longitudinal extension of the second mounting rails 3 and together form a square frame.

First bounding elements 5 in the form of longitudinally extending, straight slats are each releasably and displaceably fastened with their opposite longitudinal ends to one of the first mounting rails 2 and run perpendicular to the longitudinal extension of the first mounting rails 2 and thus parallel to the longitudinal extension of the second mounting rails 3. Here, guide sections 6 are formed at the longitudinal ends of these first bounding elements 5, which interact with holding and guide structures in the first mounting rails 2. Second bounding elements 7, which likewise have the shape of longitudinally extending, straight slats, are each releasably and displaceably fastened with their mutually opposite longitudinal ends to one of the second mounting rails 3 and run perpendicular to the longitudinal extension of the second mounting rails 3 and thus parallel to the longitudinal extension of the first mounting rails 2. Corresponding guide sections 6 are also formed at the longitudinal ends of these second bounding elements 7, which interact with holding and guide structures in the second mounting rails 3.

FIG. 5 now shows in more detail how the guidance of the longitudinal ends of the bounding elements 5 and 7 on the associated mounting rails 2 and 3 is implemented. This figure shows a sectional view in which a second mounting rail 3 of the pair of these second mounting rails 3 is shown in section and one end of a second bounding element 7 arranged on this.

In the guide section 6 shown, a guide projection 8 is provided, as in the other guide sections, which projects downwards into a longitudinal groove 9 provided on the upper side of the mounting rails 3, which here are designed as metal profiles, and is guided therein. A lock pin 11 is arranged on an arm 10 formed in the guide section 6 and which projects laterally downwards, which is shown here in a position in which it engages in a lock pin receptacle 12 which is formed on an outer side of the mounting rails 3. The lock pin 11 can be released from the lock pin receptacle 12 against the force of the spring (not shown in detail here), so that the guide section 6, guided by the guide projection 8, can then be displaced in the longitudinal direction of the mounting rails 3 such that, if the lock pin 11 is also released from a corresponding lock pin receptacle 12 at its opposite longitudinal end, at which a similar arrangement of the guide section 6 is provided, the bounding element 7 will also be released. Such lock pin receptacles 12 are provided distributed at equidistant grid intervals along the outer surface of the mounting rails 3, so that the bounding elements 7 can be freely selected and in the manner described above locked accordingly at the grid positions thus formed.

It can also be seen that when the lock pins 11 are pulled out of the lock pin receptacle 12 at both longitudinal ends, the bounding element 7 can be released from the mounting rails 3 and lifted upwards. It is therefore possible not only to adjust the magazine 1 with a different spacing setting of the bounding elements 7 but also to insert or remove bounding elements 7, i.e. to arrange bounding elements 7 in a preselected number.

A handle element 13 simplifies handling for inserting, removing and positioning the bounding elements 7. With regard to the fastening and positioning of the first bounding elements 5 on the first mounting rails 2, a similarly formed construction has been selected, so that in this regard reference can be made to the above description of FIG. 5, which also applies correspondingly to the fastening and design of the first bounding elements 5.

It can also be seen that the first bounding elements 5 are arranged in a lower height position, that the second bounding elements 7 are arranged in a height position higher thereto, so that the first bounding elements 5 and the second bounding elements 7 are in different planes and can thus be moved and positioned independently of one another.

Finally, it can also be seen that rectangular magazine compartments 14 are formed between the mutually crossing bounding elements 5 and 7. In particular, these are of the same dimensions and shape and can thus be used to hold similar, i.e. essentially identically formed, workpieces, which can thus be held and stored in such a magazine in a matrix-like arrangement.

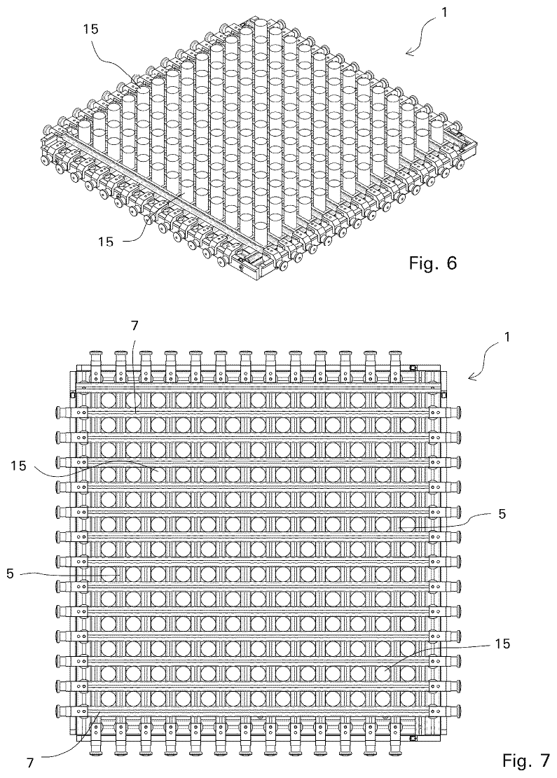

In FIGS. 5 to 10, different configurations of a magazine 1 are shown in different views, corresponding to an adaptation to the workpieces to be received therein. FIGS. 6 and 7 show a configuration with a comparatively large number of mounted and correspondingly inserted first and second bounding elements 5, 7. This creates comparatively small, square magazine compartments in which, in this example, cylindrical workpieces 15 with a comparatively small diameter are inserted.

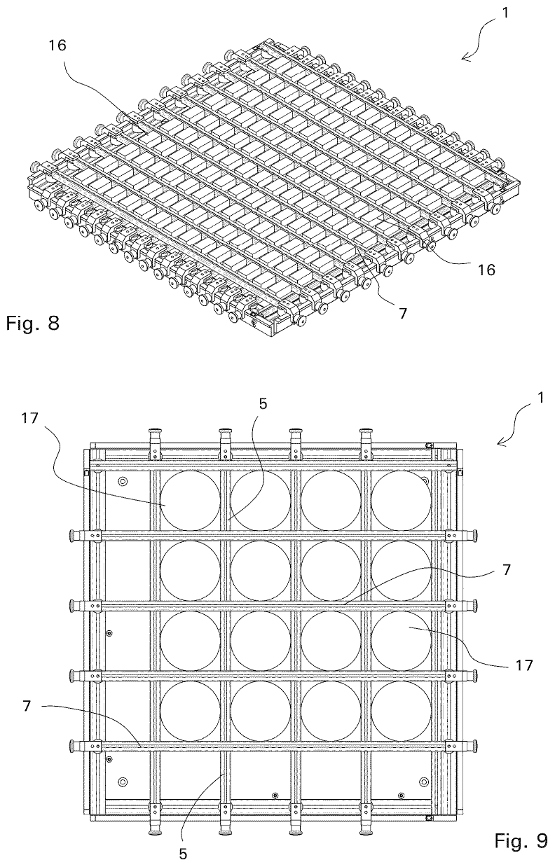

FIG. 8 shows a configuration in which rectangular magazine compartments are formed for receiving cuboid workpieces 16. Here, different numbers of first and second bounding elements 5, 7 are used and the first bounding elements 5 are positioned at equal distances from one another but different from the second bounding elements 7, which are likewise equally spaced from one another.

FIG. 9 shows a further configuration in which a smaller number of first and second bounding elements 5, 7 are used to accommodate circular-cylindrical workpieces 17 with significantly larger diameters and are positioned accordingly at a great distance from one another.

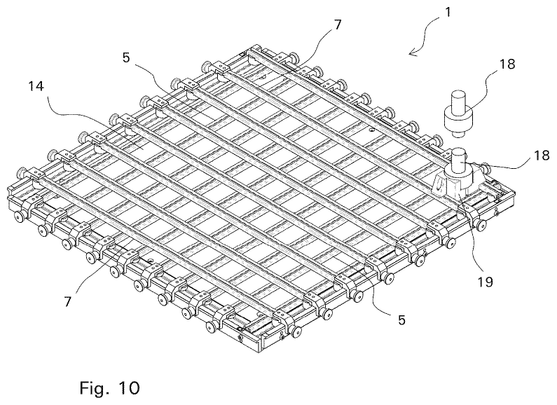

FIG. 10 shows a further possibility of forming magazines for workpieces 18 of a more complex design, in particular with a narrow footprint. For this purpose, plug-in pieces 19 can be provided which have a receptacle specifically designed for the workpiece 18 and can be inserted into the magazine compartments 14 of the magazine 1.

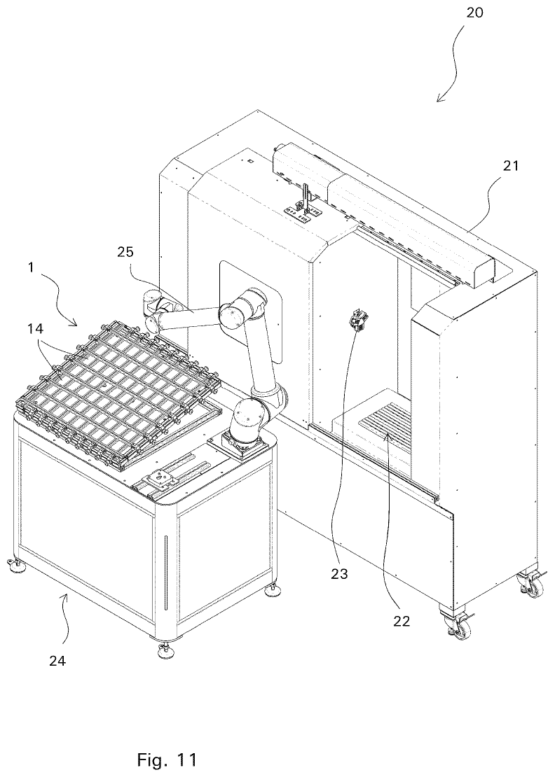

Finally, FIG. 11 shows a workpiece machining station 20 which comprises a workpiece machining machine 21, in the present case a multi-axis lathe, in which a machining space 22 is formed and a workpiece clamping device 23 arranged therein. Another component of the workpiece machining station 20 is a support block 24, on the upper side of which a magazine 1 according to the invention is fastened. This magazine 1 is shown here with a further property, namely an angle adjustment option, which results from the fact that the flat tray 4 with the mounting rails 2, 3 mounted thereon and with the bounding elements 5, 7 fastened to the mounting rails 2, 3 can be tilted about a pivot axis and locked at a set pivot angle. This can be advantageous, for example, if workpieces placed in the magazine 1 are wetted with a liquid medium, which can then drip off and run off accordingly. The robot arm 25 of a robot, designed here as a collaborative robot, is also mounted on the support block 24. With this robot arm 25, workpieces arranged in the magazine 1 are gripped during the machining process, introduced into the machining space 22 of the workpiece machining machine 21 and fed there to the clamping device 23. Likewise, following machining by the workpiece machining machine 21, the workpiece can be removed from the clamping device 23 with the aid of the robot arm 25 and either inserted into a further holding facility (not shown here) in the form of a magazine 1 or returned to a position in the magazine 1 from which it was previously removed at the beginning of the machining process.

Since a change in geometry occurs and in particular the respective centers of the workpieces that the robot arm 25 must approach with its gripper have a different position when the magazine 1 is converted for a workpiece change, for example a change from the configuration as shown in FIGS. 6 and 7 to the configuration according to FIG. 9, it is necessary to program the robot beforehand so that it knows the magazines compartment 14 to be approached and therein can grasp the workpieces accordingly, and if necessary identify them in advance. In order to make this easier, rulers can be attached to the mounting rails 2, 3, for example, from which an operator can read the positions of the first and second bounding elements 5, 7 and transfer them to a robot system. However, it is also possible, for example via an image capture and metrological evaluation of the captured image, to automatically determine the setting of the first and second bounding elements 5, 7 and then, for example via a QR code issued from an image capture system, which can also be implemented in a smartphone, to transfer it to a corresponding reading interface of the robot or to another known interface.

From the above description of possible embodiments and the figures it has become particularly clear once again which advantages the invention brings with it. It can be clearly seen that a significantly simplified conversion of the magazine 1 according to the invention results and that a very easy to determine and defined position of the workpieces in the respective corrugated magazine compartments 14 is achieved by the workpieces abutting their outer edges against the respectively adjacent bounding elements 5, 7 and in this way a central point or central axis position can be easily deduced.

### LIST OF REFERENCE SIGNS

1 magazine
2 first mounting rail
3 second mounting rail
4 flat tray
5 first bounding element
6 guide section
7 second bounding element
8 projection
9 longitudinal groove
10 arm
11 lock pin
12 lock pin receptacle
13 handle element
14 magazine compartment
15 workpiece
16 workpiece
17 workpiece
18 workpiece
19 plug-in piece
20 workpiece machining station
21 workpiece machining machine
22 machining space
23 workpiece clamping
24 support block
25 robot arm

1. A magazine for holding a plurality of workpieces (in a workpiece machining process comprising:
a tray;
at least one sectioning element that can be arranged in different positions in an area of the tray for geometrically determining and bounding a plurality of setdown positions for the plurality of workpieces on the tray;
a first pair of mounting rails that run parallel to one another, are opposite one another and are mounted on the tray along a first direction or an x direction;
a second pair of mounting rails that run parallel to one another, are opposite one another and are mounted on the tray along a second direction or a y direction that is perpendicular to the first direction or the x direction;
wherein each of the sectioning elements are formed by a plurality of first slat- or rod-shaped bounding elements that are positionally displaceable and with their longitudinal direction in the second direction or the y direction;
wherein each of the sectioning elements are fastened to each one of the first pair of mounting rails, by a plurality of second slat- or rod-shaped bounding elements;
wherein each of the plurality of second slat- or rod-shaped bounding elements can be displaced in position and can be fastened with their longitudinal direction in the first direction of the x direction to each one of second pair of mounting rails;
wherein each one of the first pair of mounting rails, each one of the second pair of mounting rails, a plurality of first bounding elements and a plurality of second bounding elements are designed and coordinated with one another in such a manner that, regardless of the arrangement and positioning of the plurality of first bounding elements and the plurality of second bounding elements on the respectively associated pair of first or second pairs of mounting rails, the respective other plurality of second or first bounding elements can be arranged and fastened to the respectively associated pair of first or second pairs of mounting rails.

2. The magazine according to claim 1, further comprising:
guide sections formed in a region of a longitudinal end of each of the first and second bounding elements and by holding structure and guide structure provided in each of the first and second pairs of mounting rails for receiving and guiding the guide sections of the corresponding first or second bounding elements.

3. The magazine according to claim 2, wherein the holding and guide structures in the mounting rails of the first pair of mounting rails are provided in a first height position of a third direction or a z direction running perpendicular not only to the first direction or the x direction but also to the second direction or the y direction along the first direction or the x direction;
wherein the holding and guide structures in the mounting rails of the second pair of mounting rails are provided in a second height position of the third direction or the z direction running along the second direction or the y direction; and
wherein the first and the second height positions are selected such that the first bounding elements and the second bounding elements are arranged in different positions along the third direction or the z direction such that they rest on one another or do not touch one another and can thus be displaced independently of one another.

4. The magazine according to claim 2, wherein the holding and the guide structures in first and second pairs of the mounting rails at least one first latching means are provided at a predetermined grid position, for interaction with at least one second latching means provided in a region of the guide sections of the first and second bounding elements in order to position and fasten the first and second bounding elements at the predetermined grid position on the first and second pairs of mounting rails.

5. The magazine according to claim 2, wherein, the holding and the guide structures in the first and second pairs of mounting rails and the guide sections of the first and second bounding elements are designed in such a manner that the first and second bounding elements are each integrated into the holding and guide structures of the associated pair of mounting rails of the first and second pairs of mounting rails and can be removed from these holding and guide structures in order to be able to variably adjust the number of the respective plurality of first and second bounding elements.

6. The magazine according to claim 1, wherein the flat tray is arranged on a base and can be tilted relative to the base at an in particular selectable adjustable angle about a pivot axis.

7. The magazine according to claim 6, wherein the pivot axis is arranged parallel to a mounting rail of the first and second pairs of mounting rails and in particular in the region thereof.

8. The magazine according to claim 1, further comprising:
at least one plug-in piece which can be inserted into at least one compartments formed between the first and second bounding elements and which have a receptacle for receiving one of the plurality of workpieces.

9. The magazine according to claim 1, wherein the first pair of mounting rails and the second pair of mounting rails together form a frame which, in a plan view, encloses an inner support region.

10. The magazine according to claim 1, wherein each of the first and second pairs of mounting rails are of equal length.

11. The magazine according to claim 1, wherein the magazine is arranged on a roller table.

12. A machining station for the machining of a plurality of workpieces with a workpiece machining machine comprising:
a workpiece feed station for positioning the plurality of workpieces to be sequentially machined in the workpiece machining machine or for positioning a plurality of finished workpieces removed from the workpiece machining machine;
a robot for automatically loading the workpiece machining machine with the plurality of work workpieces provided in the workpiece feed station or for unloading the workpiece machining machine and placing a plurality of machined workpieces in the workpiece feed station;
a magazine is provided in the workpiece feed station;
wherein the magazine comprises:
a tray;
at least one sectioning element that can be arranged in different positions in an area of the tray for geometrically determining and bounding a plurality of setdown positions for the plurality of workpieces on the tray;
a first pair of mounting rails that run parallel to one another, are opposite one another and are mounted on the tray along a first direction or an x direction;
a second pair of mounting rails that run parallel to one another, are opposite one another and are mounted on the tray along a second direction or a y direction that is perpendicular to the first direction or the x direction;
wherein each of the sectioning elements are formed by a plurality of first slat- or rod-shaped bounding elements that are positionally displaceable and with their longitudinal direction in the second direction or the y direction;
wherein each of the sectioning elements are fastened to each one of the first pair of mounting rails, by a plurality of second slat- or rod-shaped bounding elements;
wherein each of the plurality of second slat- or rod-shaped bounding elements can be displaced in position and can be fastened with their longitudinal direction in the first direction of the x direction to each one of second pair of mounting rails;
wherein each one of the first pair of mounting rails, each one of the second pair of mounting rails, the plurality of first bounding elements and the plurality of second bounding elements are designed and coordinated with one another in such a manner that, regardless of the arrangement and positioning of the plurality of first bounding elements and the plurality of second bounding elements on the respectively associated pair of first or second pairs of mounting rails, the respective other plurality of second or first bounding elements can be arranged and fastened to the respectively associated pair of first or second pairs of mounting rails.

13. The machining station according to claim 12, wherein the robot is a collaborative robot.

14. The magazine according to claim 10, wherein the roller table has means for a positionally determined connection to a workpiece feed station of a machine station for the machines of the plurality of workpieces.
